(19) United States
(12) Patent Application Publication
(10) Pub. No.: US 2020/0108426 A1
(43) Pub. Date: Apr. 9, 2020

(54) Glassware cleaning and drying equipment for medical experiments

(71) Applicant: Meijun Wu, Zibo City (CN)

(72) Inventor: Meijun Wu, Zibo City (CN)

(21) Appl. No.: 16/706,865

(22) Filed: Dec. 9, 2019

(30) Foreign Application Priority Data
Aug. 27, 2019 (CN) 2019107959958

(51) Int. Cl. B08B 7/04; D01B 1/20; B08B 1/00; B08B 1/02; B08B 3/04

(52) U.S. Cl. CPC B08B 7/04; D01B 1/20; D10B 2201/10; B08B 1/02; B08B 3/041; B08B 1/002

(57) ABSTRACT

The invention discloses a glassware cleaning and drying equipment for medical experiments, which includes a device cabinet, wherein a cleaning space is provided in the device cabinet, a brushing space communicating with the cleaning space is provided on a bottom wall of the cleaning space, and a water pump is fixedly installed in the left inner wall of the brushing space. The nozzle is fixedly installed on the output pipe. The brushing motor is started. The brushing motor drives the gear shaft to rotate. The brush cylinder and the washing brush that the gear shaft rotates rotate. The medical glassware is cleaned and disinfected. The effect of individual treatment is better and the disinfection is more thorough. The chuck can be changed according to the size of the clamped utensils. There is no need to change the mold for clamping the utensils.

### CROSS-REFERENCES TO RELATED APPLICATIONS

The present application claims priority from Chinese application No. 2019107959958 filed on Aug. 27, 2019 which is hereby incorporated by reference in its entirety.

### FIELD OF TECHNOLOGY

The invention relates to the field of medical experiments, and in particular relates to a glassware cleaning and drying equipment for medical experiments.

### TECHNICAL FIELD

In medical experiments, the utensils used are generally glassware. The texture of the glassware is brittle, and it is very inconvenient to clean. At present, the equipment for cleaning glassware can generally only adapt to the same type of glassware. There are various types of glassware used in medicine, and the fixtures used to clean different types of utensils need to be replaced, which is time-consuming.

After the medical glassware is cleaned, it must be sterilized to ensure the next use. Generally, it is carried out in batches during drying and disinfection. It cannot be more effective for each piece of sterilization.

### CONTENT OF THE INVENTION

The object of the present invention is to provide a glassware cleaning and drying device for medical experiments, which is used to overcome the above-mentioned defects in the prior art.

A glassware washing and drying device for medical experiments according to an embodiment of the present invention includes a device box, a cleaning space is provided in the device box, and a bottom wall of the cleaning space is provided to communicate with the cleaning space. A brushing space, the washing space is provided with a washing mechanism for washing glassware, and the washing mechanism includes a brushing drum rotatingly arranged in the brushing space, and the brushing drum is provided with a brushing cylinder for washing glassware A cleaning pump, a water pump is fixedly installed in the left inner wall of the brushing space, and a spray head is fixed on the output pipe of the water pump, and the water pump can spray the cleaning water in the brushing space onto the glassware for flushing through the spray head, A drying space connected to the cleaning space is provided on the right side, and a drying mechanism capable of sterilizing and drying glassware is provided in the drying space, and an upper side of the cleaning space is provided to drive the glassware from a transmission mechanism moving left to right, the conveying mechanism includes a first sprocket space and a second sprocket space provided on the upper side of the cleaning space, the first sprocket space is rotatably installed in the first sprocket space, and the second sprocket space is rotative A second sprocket is installed, and a chain is driven between the second sprocket and the first sprocket. A clamping rod is fixedly installed on the chain, and the clamping rod is provided with a glass clamping device. A chuck, a chute is provided on the top surface of the cleaning space, and the chuck is slidably installed between the chute and the width of the chute can control the chuck to clamp and lower the glassware to make the glassware It can be moved from the washing space to the drying space for drying.

On the basis of the above technical solution, the cleaning mechanism further includes a gear space provided on the lower side of the brushing space, and three pairs of gear shafts are rotationally mounted back and forth symmetrically between the gear space and the brushing space, and the gear shaft is fixedly mounted on the gear shaft. A gear, the gears on the left and right sides mesh with each other, the gear shaft is fixedly connected to the scrubbing cylinder, a brush motor is symmetrically fixed back and forth in the bottom wall of the gear space, and the output shaft of the brush motor is in the middle The gear shafts are fixedly connected.

Based on the above technical solution, a partition curtain is fixedly installed on the top wall of the cleaning space.

Based on the above technical solution, a suction pipe is connected to the input port of the water pump, and the suction pipe is in communication with the scrubbing space.

Based on the above technical solution, the drying mechanism includes a blast space provided on the bottom wall of the chain, a drying motor is fixedly installed on the bottom wall of the blast space, and the output shaft of the drying motor is fixedly installed A fan, a heater is fixedly installed in the blast space, and a communication air inlet is provided between the bottom wall of the blast space and the bottom surface of the device box. Based on the above technical solution, a sterilizer is fixedly installed on the top wall of the drying space.

Based on the above technical solution, a partition motor is fixedly installed in the device box, a threaded rod is fixedly installed on the output shaft of the partitioned motor, and a partition plate is threadedly installed on the threaded rod.

Based on the above technical solution, the transmission mechanism further includes a transmission motor fixedly installed in the top wall of the second sprocket space, the output shaft of the transmission motor is fixedly connected to the second sprocket, and the clamping A rod is slidably connected to the device box, and a pushing spring is fixedly installed between the chuck and the clamping rod, and the pushing spring can push the chuck to always contact the slide groove, and the chuck is fixed on the chuck. A fixing block is installed, the clamping block is provided with a clamping block, and a spring space is provided in the clamping block. The clamping block is slidably installed in the spring space. A spring is fixedly installed between the inner walls on one side of the fixing block.

On the basis of the above technical solution, a fixing seat is fixedly installed on the bottom wall of the drying space, and the fixing seat is provided with a first sliding space with an upward opening, and a first motor is fixedly installed on the left inner wall of the first sliding space. A first threaded shaft is fixedly installed on the first motor output shaft, a first slide table is slidably installed on the fixed seat, the first slide table is threadedly installed with the first threaded shaft, and the first slide table A second sliding table is slidably mounted on the first sliding table, and a second sliding space is provided on the first sliding table. A second motor is fixedly mounted on the inner wall of the rear side of the second sliding space, and a second motor is fixedly mounted on the second motor output shaft. A threaded shaft, the second threaded shaft is screw-mounted with the second slide table, and a placing table is placed on the top surface of the second slide table.

The beneficial effect of the present invention is that the present invention can separately and continuously clean and disinfect medical glassware. The effect of single treatment is better, the disinfection is more thorough, and different types of glassware can be cleaned. And drying process, the chuck can be changed according to the size of the clamped utensil, so that the mold for clamping the utensil does not need to be changed during processing, so that the present invention has high flexibility, and when the utensil is put down, it can The precise controller is placed in the corresponding position, which is worth promoting.

### BRIEF DESCRIPTION OF THE DRAWINGS

In order to more clearly explain the embodiments of the present invention or the technical solutions in the prior art, the drawings used in the embodiments will be briefly introduced below. Obviously, the drawings in the following description are only some of the invention For those of ordinary skill in the art, other embodiments may be obtained based on these drawings without paying creative effort.

FIG. 1 is a schematic diagram of the overall structure of the present invention;

FIG. 2 is a schematic cross-sectional structure view taken along the direction A-A in FIG. 1;

FIG. 3 is a schematic cross-sectional structure view taken along the B-B direction in FIG. 1;

FIG. 4 is an enlarged structure diagram at a position C in FIG. 1.

### DETAILED DESCRIPTION OF THE INVENTION

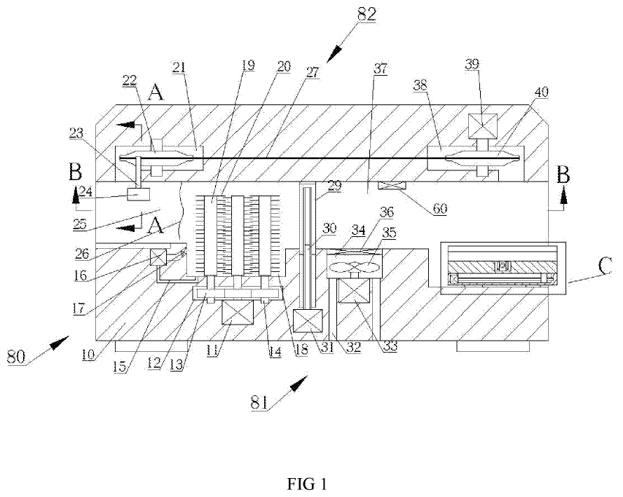

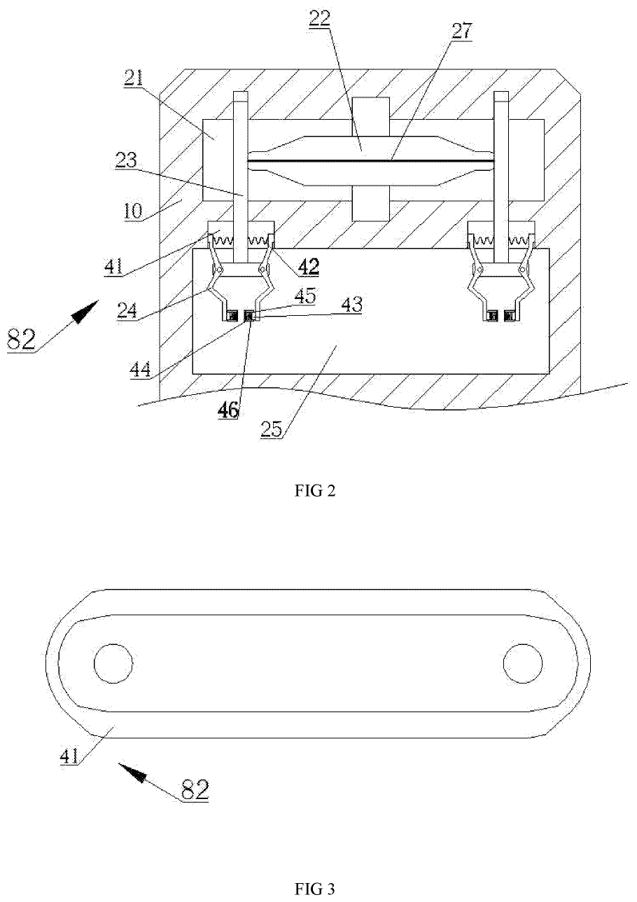

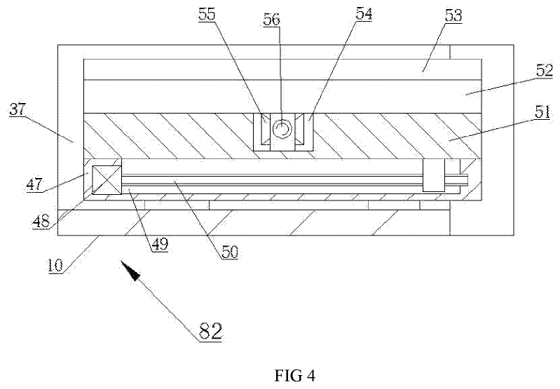

The present invention will be described in detail below with reference to FIGS. 1-4. Among them, for convenience of description, the orientation described below is specified as follows: the up-down, left-right, left-right, and up-down directions described below are consistent with the front-back, left-right, up, down, and down directions of the view direction of FIG. 1, 1 is a front view of the device of the present invention, and the direction shown in FIG. 1 is the same as the front, rear, left, right, and up and down directions of the device of the present invention.

Referring to FIGS. 1-4, a glassware cleaning and drying device for medical experiments according to an embodiment of the present invention includes a device case 10, which is provided with a cleaning space 25 therein. A brushing space 18 communicating with the cleaning space 25 is provided on the wall, and a cleaning mechanism 80 for cleaning glassware is provided in the cleaning space 25. The cleaning mechanism 80 includes a rotation mechanism disposed in the brushing space 18. A scrubbing cylinder 19 is provided with a cleaning brush 20 that can be used to scrub glassware. A water pump 16 is fixedly installed in the left inner wall of the scrubbing space 18, and a nozzle 17 is fixedly installed on the output pipe of the water pump 16. The water pump 16 can spray the washing water in the brushing space 18 onto the glassware through the nozzle 17 for washing. A drying space 37 connected to the washing space 25 is provided on the right side of the washing space 25, and the drying space 37 A drying mechanism 81 for sterilizing and drying glassware is provided therein, and a conveying mechanism 82 for moving the glassware from left to right is provided on the upper side of the cleaning space 25, the conveying mechanism 82 includes a first sprocket space 21 and a second sprocket space 38 provided on the upper side of the cleaning space 25. The first sprocket space 21 is rotatably installed in the first sprocket space 21, and the first A second sprocket 40 is rotatably installed in the two sprocket spaces 38, and a chain 27 is driven between the second sprocket 40 and the first sprocket 22, and a clamping rod 23 is fixedly installed on the chain 27. The clamping rod 23 is provided with a chuck 24 capable of clamping glassware, and a chute 41 is provided on the top surface of the cleaning space 25. The chuck 24 and the chute 41 are slidingly installed. The width of the chute 41 can control the chuck 24 to clamp and lower the glassware, so that the glassware can be washed and moved from the cleaning space 25 to the drying space 37 for drying.

In addition, in one embodiment, the cleaning mechanism 80 further includes a gear space 12 disposed below the brushing space 18, and three pairs of gear shafts 14 are rotatably mounted back and forth between the gear space 12 and the brushing space 18, A gear 13 is fixedly installed on the gear shaft 14, the gears 13 on the left and right sides mesh with each other, the gear shaft 14 is fixedly connected to the brushing cylinder 19, and the front and back of the gear space 12 are symmetrically fixed in the bottom wall. The brushing motor 11 is fixedly connected between the output shaft of the brushing motor 11 and the gear shaft 14 in the middle, so that the brushing motor 11 is started, the brushing motor 11 drives the gear shaft 14 to rotate, the gear shaft 14 rotates the brushing cylinder 19 and cleansing The brush 20 rotates, and the cleaning brush 20 can clean the glassware sent to the upper side of the brushing space 18.

In addition, in one embodiment, a partition curtain 26 is fixedly installed on the top wall of the cleaning space 25, and the partition curtain 26 can prevent water from being splashed when the utensils are cleaned.

In addition, in one embodiment, a water suction pipe 15 is connected to the input port of the water pump 16, and the water suction pipe 15 is in communication with the scrubbing space 18, so that the water pump 16 is started, and the water pump 16 sucks the cleaning in the scrubbing space 18. Water is sprayed on glassware to rinse.

In addition, in one embodiment, the drying mechanism 81 includes a blast space 34 provided on a bottom wall of the chain 27, and a drying motor 33 is fixedly installed on the bottom wall of the blast space 34. A fan blade 35 is fixed on the output shaft of the motor 33, and a heater 36 is fixed in the blast space 34. A communication air inlet 32 is provided between the bottom wall of the blast space 34 and the bottom surface of the device box 10. After the glassware is transferred into the drying space 37, the heater 36 is powered on, the drying motor 33 is started, and the drying motor 33 drives the fan blade 35 to rotate, so that the transferred glassware is dried.

In addition, in one embodiment, a sterilizer 60 is fixed on the top wall of the drying space 37, and the sterilizer 60 can generate ultraviolet rays for sterilization.

In addition, in one embodiment, a partitioning motor 31 is fixedly installed in the device case 10, and a threaded rod 30 is fixedly mounted on the output shaft of the partitioning motor 31, and a partitioning plate 29 is threadedly mounted on the threaded rod 30. When partitioning the motor 31, the partitioning motor 31 drives the threaded rod 30 to rotate, and the threaded rod 30 drives the partitioning plate 29 to separate the drying space 37 and the washing space 25 upward.

In addition, in one embodiment, the transmission mechanism 82 further includes a transmission motor 39 fixedly installed in the top wall of the second sprocket space 38, and an output shaft of the transmission motor 39 is fixed to the second sprocket 40. Connection, the clamping rod 23 is slidably connected with the device box 10, and a pushing spring 42 is fixedly installed between the clamping head 24 and the clamping rod 23, and the pushing spring 42 can push the clamping head 24 and The chute 41 is in contact with each other. A fixing block 43 is fixed on the chuck 24. A clamping block 44 is provided on the fixing block 43. A spring space 45 is provided in the clamping block 44. The block 44 is slidably installed in the spring space 45. A spring 46 is fixedly installed between the inner wall on one side of the spring space 45 and the inner wall on the other side of the fixing block 43. When the chain 27 drives the clamping lever 23 and the clamping lever 23 to rotate to At the left and right sides, the chuck 24 is opened, and the chuck 24 on the right side can put the vessel down. After the chuck 24 on the left side is opened, the glassware can be placed between the chucks 24, so that the clamping block 44 will The ware is clamped and transported, ready for washing and drying.

In addition, in one embodiment, a fixing base 47 is fixedly installed on the bottom wall of the drying space 37, and a first sliding space 49 with an upward opening is provided on the fixing base 47, and the left inner wall of the first sliding space 49 is A first motor 48 is fixedly mounted on the first motor 48, and a first threaded shaft 50 is fixed on an output shaft. A first slide table 51 is slidably mounted on the fixed seat 47, and the first slide table 51 and the first A threaded shaft 50 is threadedly installed, a second slide table 52 is slidably mounted on the first slide table 51, a second slide space 54 is provided on the first slide table 51, and a rear inner wall of the second slide space 54 is provided A second motor 55 is fixedly mounted, and a second threaded shaft 56 is fixedly mounted on the output shaft of the second motor 55. The second threaded shaft 56 is threadedly installed with the second slide table 52, and the second slide table 52 is mounted on the top. A placing table 53 is placed on the surface. When the glassware is transferred to the right, the first motor 48 is started. The first motor 48 drives the first threaded shaft 50 to rotate, so that the first sliding table 51 can move left and right, and the second motor 55 is started. The second motor 55 drives the second threaded shaft 56 to rotate, so that the second slide table 52 can move forward and backward By moving the front and rear and cooperate with each other, so that the glassware is completed after cleaning and drying can be placed accurately determine the position of the platen 53.

When the glassware needs to be cleaned, the transmission motor 39 is started. The transmission motor 39 drives the second sprocket 40 to rotate. The rotation of the second sprocket 40 can drive the chain 27 to rotate, and the chain 27 drives the clamping rod 23 and the clamping rod 23 to the left. When it is on the side, the left chuck 24 is opened, and glassware can be placed between the chucks 24, so that the clamping block 44 transfers the ware to the upper side of the brushing space 18, and starts the brushing motor 11, which is driven by the brushing motor 11. The gear shaft 14 rotates, and the brush cylinder 19 and the washing brush 20 which rotate the gear shaft 14 rotate. The washing brush 20 can clean the glassware sent to the upper side of the washing space 18, and the water pump 16 is started, and the water pump 16 sucks the The washing water is sprayed on the glassware for rinsing. When the glassware is transferred into the drying space 37, the heater 36 is powered on, the drying motor 33 is started, and the drying motor 33 drives the fan blade 35 to rotate, so that the glass transferred The utensils are dried. The sterilizer 60 can generate ultraviolet rays for disinfection.

When the glassware is transferred to the right, the first motor 48 is started. The first motor 48 drives the first threaded shaft 50 to rotate, so that the first slide table 51 can move left and right, the second motor 55 is started, and the second motor 55 drives the first The two threaded shafts 56 are rotated, so that the second slide table 52 can be moved back and forth, and the left and right and back and forth movements cooperate with each other, so that the glassware that has been cleaned and dried can be accurately placed on the determined position of the placing table 53.

The beneficial effect of the present invention is that the present invention can separately and continuously clean and disinfect medical glassware. The effect of single treatment is better, the disinfection is more thorough, and different types of glassware can be cleaned. And drying process, the chuck can be changed according to the size of the clamped utensil, so that the mold for clamping the utensil does not need to be changed during processing, so that the present invention has high flexibility, and when the utensil is put down, it can The precise controller is placed in the corresponding position, which is worth promoting.

Those skilled in the art can clearly understand that various modifications to the above embodiments can be made without departing from the overall spirit and concept of the present invention. They all fall within the protection scope of the present invention. The protection scheme of the present invention is subject to the claims attached to the present invention.

1. A purlin production equipment for a knitting industry, comprising a production box, characterized in that: a production space is provided in the production box, and a scraper blade connected to the production space is provided on the bottom wall of the production space. Space, the knife seat is slidably installed in the scraper space, and a scraper blade capable of scraping bamboo strips is fixedly installed on the knife seat. A first transfer cylinder space is provided in the top wall of the production space, and the first transfer cylinder The space is provided with a transmission mechanism capable of driving the bamboo strips to move in the production space. When the transmission mechanism transports the bamboo strips into the production space, the scraper scrapes off the burrs and burrs on the bamboo strips, a cutting tool space connected to the cutting tool space is provided in the production space; a cutting tool holder is slidably installed in the cutting tool space. A cutting knife capable of dividing a bamboo strip is fixedly installed on the cutting tool space. After being transferred to the tool space, the tool holder drives the cutter to cut the bamboo strips into purlins to the right. The tool holder is connected with a power mechanism that drives the tool holder to move. A partition plate is fixedly installed between the inner walls; the partition plate can divide the production space into upper and lower parts, so that the upper and lower parts of the split purlin can be separated.

2. The knives production equipment for knitting industry according to claim 1, wherein the conveying mechanism comprises a first pulley cavity provided on the rear side of the space of the first conveying cylinder, and the first A first transfer cylinder shaft is installed in a left-right symmetrical rotation between a transfer cylinder space and the first pulley cavity, and the first transfer cylinder is fixedly mounted on the first transfer cylinder axis in a left-right symmetrical manner. A first pulley is fixedly mounted symmetrically on the cylinder shaft left and right, a first belt is driven between the first pulleys on the left and right sides, and a first motor is fixedly installed in the rear inner wall of the first pulley cavity. The output shaft of the first motor is fixedly connected to the right first transfer cylinder shaft.

3. The purlin production equipment for knitting industry according to claim 1, characterized in that: three guide wheels are rotatably installed on the top wall of the production space.

4. The purlin production equipment for knitting industry according to claim 1, characterized in that: a knob is threadedly installed between the bottom wall of the scraper space and the bottom surface of the boss on the right side of the production box, and The knob is rotatably installed with the knife seat.

5. The purlin production equipment for knitting industry according to claim 1, characterized in that: a rubber sleeve is installed in the production space at a high level, a bottom wall of the production space and a right boss of the production box There are communicating discharge openings between the bottom surfaces.

6. The purlin production equipment for knitting industry according to claim 1, characterized in that: a second transfer cylinder space communicating with the production space is provided in the upper and lower inner walls of the production space, and the second A second pulley cavity is provided at the rear side of the transfer cylinder space, and a second transfer cylinder shaft is rotatably mounted vertically between the second pulley cavity and the second transfer cylinder space. A second conveying cylinder is fixedly installed vertically symmetrically, the second conveying cylinder is located in the second pulley cavity, and a second pulley is symmetrically fixedly installed vertically. Two belts, a second motor is fixedly installed in the inner wall of the rear side of the second pulley cavity, and an output shaft of the second motor is fixedly connected with a second transmission cylinder shaft on the lower side.

7. The knives production equipment for the knitting industry according to claim 1, wherein the power mechanism comprises a switching motor fixedly installed in an inner wall on the right side of the tool space, and the switching motor output shaft A long cylindrical gear is fixedly installed on the rear side of the tool holder. A rack is provided on the rear side of the tool holder. The rack on the tool holder meshes with the long cylindrical gear. An electromagnet is fixed on the left inner wall of the tool space. A permanent magnet is fixedly installed on the left side of the tool holder.

7. The purlin production equipment for knitting industry according to claim 1, characterized in that: the top wall of the production space is provided with a clamping space communicating with the production space, and the clamping space A clamping plate is slidingly installed inside, and a first spring is fixedly installed between the top surface of the clamping plate and the top wall of the clamping space.

8. The purlin production equipment for knitting industry according to claim 1, characterized in that: a top plate is slidably installed on the right side of the partition plate, a spring space is provided in the top plate, and the partition plate extends Into the spring space, a second spring is fixedly installed between the right side surface of the partition plate and the right inner wall of the spring space, and the second spring and the tool holder are always in contact with each other. The collection table is fixedly installed on the left side of the box.
